(19) United States
(12) Patent Application Publication
(10) Pub. No.: US 2005/0190483 A1
(43) Pub. Date: Sep. 1, 2005

(54) Recording device, recording method, and recording system

(75) Inventor: Hiroyoshi Iketo, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/054,429

(22) Filed: Feb. 10, 2005

(30) Foreign Application Priority Data
Feb. 26, 2004 (JP) 2004-052382

(51) Int. Cl. G11B 17/00

(52) U.S. Cl. 360/69

(57) ABSTRACT

A recording device has a recording medium, such as an HDD, for recording information signals such as an audio signal and a video signal. When it is detected that the recording device is connected to a cradle serving as a power supply, the power supply supplies the continuous power to the recording device, and a fragmentation rate of the information signal recorded to the recording medium is a predetermined value or more, the defragmentation of the recording medium is automatically executed. Thus, the damage of the recording medium due to the vibrations and the unnecessary power-consumption of battery are prevented and the convenience of the automatic defragmentation is ensured.

### CROSS-REFERENCE TO RELATED APPLICATIONS

This application is based upon and claims the benefit of priority from the prior Japanese Patent Application No. 2004-52382 filed on Feb. 26, 2004; the entire contents of which are incorporated herein by reference.

### BACKGROUND OF THE INVENTION

1. Field of the Invention

The present invention relates to a recording device including a recording medium such as an HDD (Hard Disk Device), and a recording method and a recording system thereof. Further, the present invention relates to a recording device, a recording method, and a recording system, in which the damage of HDD and the unnecessary battery consumption are prevented and the defragmentation for solving the fragmentation of a free area in the HDD is performed.

2. Description of the Related Art

Generally, a recording medium, such as an HDD serving as a recording medium of a personal computer or a video recording and playing device, does not record data to a continuous recording area when the data is repeatedly recorded and deleted, and thus a free recording area is fragmented (so-called fragmentation). The more times the recording and deletion are repeated, the finer the fragmentation is caused. The advance of fragmentation increases the processing amount of an OS (Operating System) and the amount of movement of a drive head, thus deteriorating a reading and writing speed.

The HDD is reduced in size and is provided for a portable device. Generally, as the size of the HDD is smaller, a higher transfer rate is not ensured. On the other hand, the number of applications which requires high performance, e.g., video real-time recording, is increased. The above devices need the defragmentation to prevent the deterioration of performance.

As one well-known art, Japanese Unexamined Patent Application Publication No. 2001-236717 discloses an information recording and playing device which executes the defragmentation by determining a status in which a running vibration of a moving member or mechanical vibration does not influence the recording medium.

Conventionally, the defragmentation is executed with a dedicated tool that a user manually uses or by formatting the HDD. This method is not convenient for the user and the fragmentation rate of the HDD for manual operation is not continuously kept to be a predetermined one.

In consideration of the above-mentioned points, preferably, the defragmentation is automatically executed. For example, there is provided one well-known method for automatically continuing fragmented free areas by automatically starting a defragmentation program by user operation or at a preset time interval on a personal computer.

During the defragmentation, a head continuously exists on a disk and repeats the reading/writing operation to/from the disk and thus a problem for increasing the power consumption is caused. Therefore, when a mobile device is operated irrespective of situations, the following programs are caused.

First, the vibration might damage the HDD. Secondly, the battery consumption is high.

Japanese Unexamined Patent Application Publication No. 2001-236717 relates to the defragmentation of the recording and playing device “which is attached to a vehicle moving body such as an automobile or a train”, but does not relate to the mobile device. Therefore, in Japanese Unexamined Patent Application Publication No. 2001-236717, a power supply is not described and further section for preventing the battery consumption is not described.

### SUMMARY OF THE INVENTION

In view of a placing status of the device, a status of supplying the power, and a fragmentation rate being satisfactory, it is an object of the present invention to provide a recording device, a recording method, and a recording system, in which the defragmentation is automatically executed, the damage of the recording medium and the battery consumption are prevented, and the user's convenience due to the automatic execution of defragmentation is ensured.

According to one aspect of the present invention, a recording device comprises:

a recording medium for recording an information signal;

a first detecting section which detects that the recording medium is connected to a power supply;

a second detecting section which detects that continuous power is supplied to the recording device from the power supply;

a third detecting section which detects that a fragmentation rate of the information signal recorded to the recording medium is a predetermined value or more; and

a defragmentation automatic executing section which automatically executes defragmentation of the recording medium when the first detecting section detects the connection to the power supply, the second detecting section detects a status for ensuring the continuous power, and the third detecting section detects that the fragmentation rate of the recording medium is a predetermined value or more.

In addition, the above-mentioned recording device further comprises:

an inner secondary battery;

a fourth detecting section which detects that continuous power is shut down or the recording device is detached from the power supply during executing the defragmentation;

a switching section which switches the power supply to that from the inner secondary battery when the fourth detecting section detects that the continuous power is shut down or the recording device is detached from the power supply;

an ending section which ends the defragmentation when the switching section switches the power supply to that from the inner secondary battery;

a fifth detecting section which detects that the recording device is connected to the power supply and the continuous power is ensured after the ending section ends the defragmentation; and

a control section which controls an operation for executing the subsequent defragmentation when the fifth detecting section detects that the recording device is connected to the power supply and the continuous power is ensured.

In addition, according to another aspect of the present invention, a recording method of a recording device for defragmentation of an information signal recorded to a recording medium provided for the recording device, comprises:

a first detecting step of detecting that a recording medium is connected to a power supply;

a second detecting step of detecting that continuous power is supplied to the recording device from the power supply;

a third detecting step of detecting that a fragmentation rate of the information signal recorded to the recording medium is a predetermined value or more; and

a defragmentation automatic executing step of automatically executing defragmentation of the recording medium when the first detecting step detects the connection to the power supply, the second detecting step detects a status for ensuring the continuous power, and the third detecting step detects that the fragmentation rate of the recording medium is a predetermined value or more.

In addition, according to another aspect of the present invention, a recording system comprises:

a cradle which can supply power to a mobile device including a recording medium by placing the mobile device thereon;

a first detecting section which is arranged to the mobile device and detects that the mobile device is placed on the cradle;

a second detecting section which is arranged to the mobile device and detects that continuous power is supplied to the mobile device from the cradle;

a third detecting section which is arranged to the mobile device and detects that a fragmentation rate of the information signal recorded to the recording medium is a predetermined value or more; and

a defragmentation automatic executing section which automatically executes defragmentation of the recording medium when the first detecting section detects the mobile device is placed on the cradle, the second detecting section detects a status for ensuring the continuous power, and the third detecting section detects that the fragmentation rate of the recording medium is a predetermined value or more.

According to the present invention, advantageously, in view of a placing of the device, a status of supplying the power, and a fragmentation rate, the defragmentation is automatically executed, the damage of the recording medium and the battery consumption are prevented, and the user's convenience due to the automatic execution of defragmentation is improved.

### BRIEF DESCRIPTION OF THE DRAWINGS

FIG. 1 is a block diagram showing the structure of a recording system and a recording device according to a first embodiment of the present invention;

FIG. 2 is a diagram showing the structure of a detecting circuit which detects a connecting status of a mobile phone main body and a cradle serving as a power supply;

FIG. 3 is a perspective view showing a status in which the mobile phone main body is placed on the cradle;

FIG. 4 is a flowchart for defragmentation operation according to the first embodiment;

FIGS. 5A and 5B are flowcharts showing the defragmentation operation of a recording system and a recording device according to a second embodiment of the present invention, FIG. 5A is a flowchart showing the operation during executing the defragmentation, and FIG. 5B is a flowchart showing the restarting operation after the end (interrupt) of defragmentation;

FIG. 6 is a flowchart showing the defragmentation operation in a recording system and a recording device according to a third embodiment of the present invention; and

FIG. 7 is a flowchart showing the defragmentation operation in a recording system and a recording device according to a fourth embodiment of the present invention.

### DETAILED DESCRIPTION OF THE INVENTION

Embodiments of the present invention will be described with reference to the drawings.

[First Embodiment]

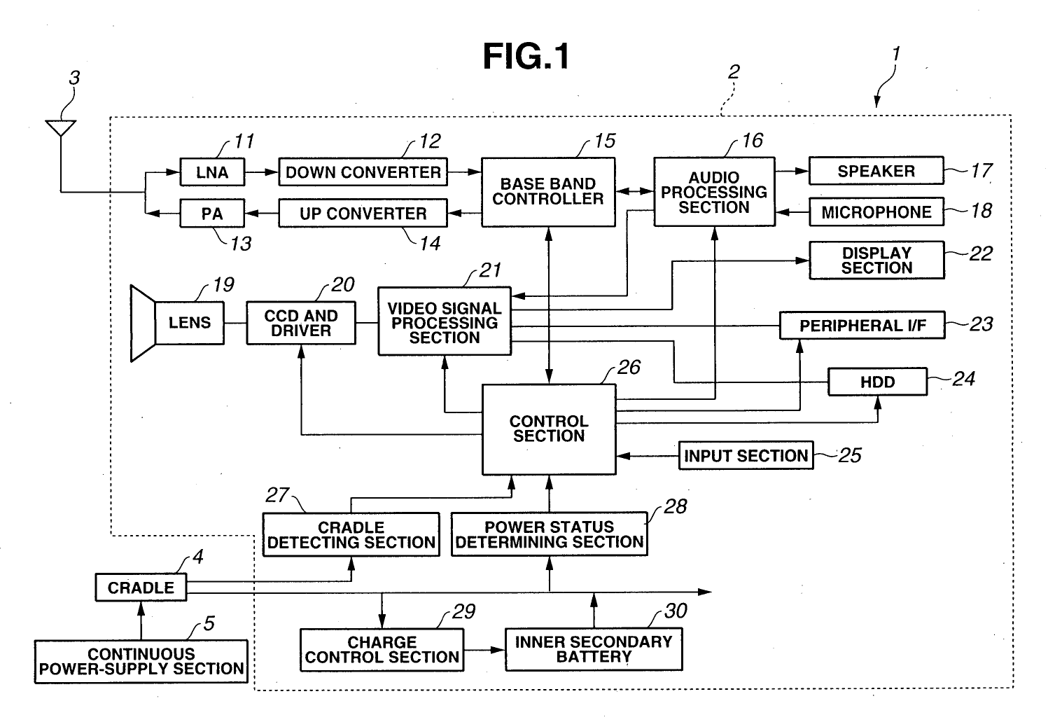

FIG. 1 is a block diagram showing the structure of a recording system and a recording device according to a first embodiment of the present invention. A description is given of an example of a mobile phone with a camera including an HDD serving as a recording device.

Referring to FIG. 1, a recording system 1 comprises: a mobile phone main body 2 serving as a recording device; an antenna 3 which receives/sends radio waves from/to the mobile phone main body 2; a cradle 4 on which the mobile phone main body 2 is placed; and a continuous power-supply section 5 which continuously supplies power to the cradle 4.

The mobile phone main body 2 serving as the recording device comprises: a receiving section comprising an LNA (Low Noise Amplifier) 11 and a down converter 12; a sending section comprising a PA (Power Amplifier) 13 and an up converter 14; a base band controller 15; an audio processing section 16; a speaker 17; a microphone 18; a photographing lens 19; a CCD serving as a solid-state image pick-up device; a driver 20 of the CCD; a video signal processing section 21; a display section 22 such as an LCD panel; a peripheral interface 23 which inputs/outputs a video signal from/to an external video device; a hard disk drive (HDD) 24 serving as a recording medium for recording the video signal picked-up by the CCD and the audio signal inputted by the microphone 18; an input section 25 serving as an operation section which turns on power and performs various operating instructions including the start of photographing and various settings including the setting for switching automatic defragmentation and manual defragmentation; a control section 26 comprising a microcomputer; a cradle detecting section 27 which detects the placement of the mobile phone main body 2 to the cradle 4; a power status determining section 28 which is connected to a power output line of the cradle 4 and detects the presence or absence of a continuous power voltage supplied to the cradle 4; a charge control section 29 which is connected to the power output line of the cradle 4 and controls the charge operation to an inner secondary battery 30; and the inner secondary battery 30.

The receiving section comprising the LNA 11 and the down converter 12 receives the radio waves having a frequency band for mobile phone via the antenna 3, and converts the received radio waves into a signal. The signal outputted from the receiving section is inputted to the base band controller 15. The base band controller 15 performs base band processing of the received signal, outputs audio data to the audio processing section 16, and outputs image data, character data, and control data to the control section 26. Further, the base band controller 15 receives the audio data from the audio processing section 16 and the character data and control data from the control section 26, converts the received data into the signal having the frequency for mobile phone, and outputs the converted signal to the sending section comprising the up converter 14 and the PA 13.

The sending section comprising the up converter 14 and the PA 13 converts the signal received from the base band controller 15, and sends the radio waves having the frequency for mobile phone via the antenna 3. The audio processing section 16 converts, into the audio signal, the audio data received from the base band controller 15, drives the speaker 17, and outputs the audio signal. Further, the audio processing section 16 converts, into the audio signal, the audio signal received from the microphone 18, and outputs the converted data to the base band controller 15.

On the other hand, an image of a subject passing through the photographing lens 19 is formed onto an image pick-up surface of the CCD by the CCD and the driver 20 thereof, is photoelectrically converted, and is inputted to the video signal processing section 21. The video signal processing section 21 processes a CCD image pick-up signal to a video signal to be displayed on the display section 22, and supplies the processed signal to the display section 22, the peripheral interface 23, and the HDD 24. The display section 22 displays the video signal, the peripheral interface 23 supplies the video signal to an external peripheral device (not shown), and the HDD 24 records and plays the video signal.

The control section 26 is, e.g., a microcomputer, and comprises: a CPU (Central Processing Unit); a ROM which stores a system program and various processing programs including a defragmentation executing program, a processing program for measuring a fragmentation rate of the HDD 24, and a setting program for automatically executing the defragmentation; and a RAM which stores data necessary for operating circuits and various setting contents including the setting for setting automatic execution of defragmentation or manual execution of defragmentation. The control section 26 instructs the operation and setting of sections in the mobile phone main body 2 based on the input signal from the input section 25. Further, when it is determined based on the presence or absence of the cradle detected by using the cradle detecting section 27, the determination of a power status by using the power status determining section 28, and a measurement value of the fragmentation rate of the HDD 24, that the cradle is present, the power status is preferable, or the fragmentation rate of HDD 24 is a predetermined one or more, respectively, and “automatic execution of defragmentation” is set to the RAM, the control section automatically executes the defragmentation executing program. If the “automatic execution of fragmentation” is not set to the RAM, the control section controls the operation so that a warning message is displayed on the display section 22.

Not only the video image but also the audio signal is recorded to the HDD 24. The video signal processing section 21 in this case comprises a high-function DSP (Digital Signal Processor) having an audio interface, an HDD interface, and a display interface.

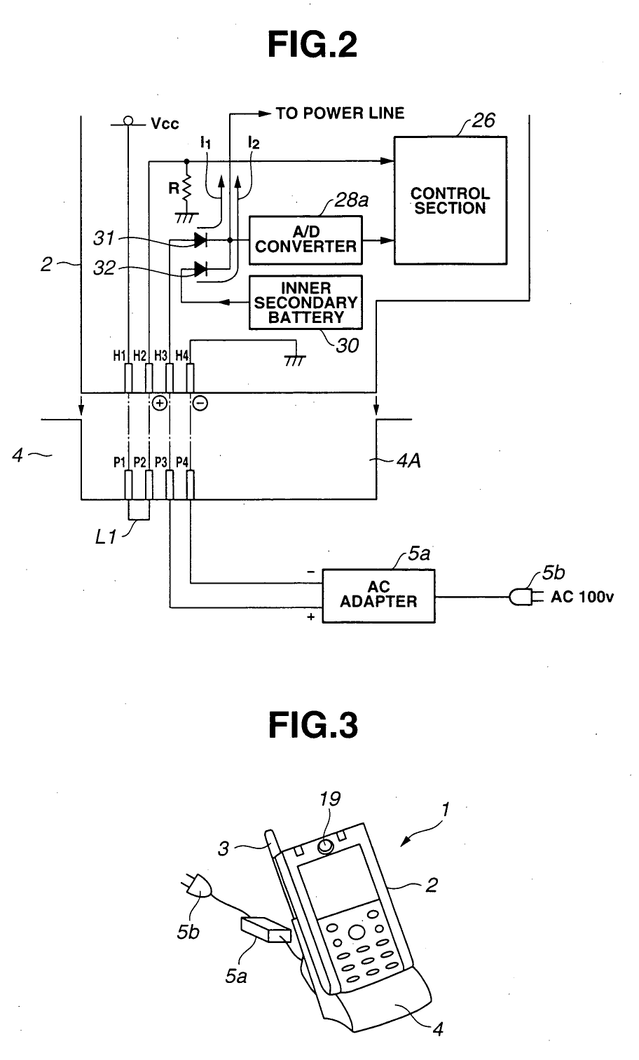

FIG. 2 is a diagram showing the structure of a detecting circuit which detects a connecting status between the mobile phone main body 2 and the cradle 4 serving as a power supply.

Referring to FIG. 2, the mobile phone main body 2 is placed and is attached to an attaching portion 4A of the cradle 4.

A plurality of connecting pins P1 to P4 comprising conductive members stand on the attaching portion 4A of the cradle 4. The connecting pins P1 to P4 can be fit into cylindrical electric connecting portions H1 to H4 at an attached portion of the mobile phone main body 2. The connecting portions H1 to H4 comprise conductive members. The connecting pins P1 and P2 and the connecting portions H1 and H2 form the cradle detecting section 27. The connecting portion H1 is connected to a power line Vcc from the inner secondary battery serving as an inner power supply of the mobile phone main body 2, and the connecting portion H2 is connected to a reference potential point of the mobile phone main body 2 via a resistor R having a predetermined resistance and further is connected to a detecting terminal (not shown) of the CPU in the control section 26. The connecting pins P1 and P2 on the cradle 4 side corresponding to the connecting portions H1 and H2 are electrically short-circuited at a connecting line L1.

The connecting pins P3 and P4 on the cradle 4 side are connected to the positive and negative output terminals of an AC adaptor 5a serving as a continuous power-supply section, respectively. Connected to an input terminal of the AC adaptor 5a is an AC plug 5b which inputs commercial AC power (AC 100V). The cylindrical connecting portions H3 and H4 arranged to the attached portion of the mobile phone main body 2 correspond to the connecting pins P3 and P4, respectively. The positive connecting portion H3 receives a DC voltage outputted from the AC adaptor 5 and supplies the DC voltage to an input terminal of an A/D converter 28a serving as a power status determining section. The negative connecting portion H4 is connected to the reference potential point of the mobile phone main body 2. In order to detect the positive DC voltage from the AC adaptor 5a as continuous power having the predetermined value or more, the A/D converter 28a converts the DC voltage (an analog value) into a digital value, and supplies the converted value to the detecting terminal of the CPU in the control section 26.

With the above structure, when the attached portion of the mobile phone main body 2 is placed to the attaching portion 4A of the cradle 4, the connecting pins P1 to P4 are fit into the connecting portions H1 to H4 to be conductively connected to each other. The connection between the connecting pins P1 and P2 and the connecting portions H1 and H2 sends the DC voltage of the inner power from the DC power line Vcc to the CPU in the control section 26. Thus, the control section 26 detects the placement or connection of the mobile phone main body 2 to the cradle 4. Further, the A/D converter 28a converts the DC voltage as the continuous power from the AC adaptor 5a into the digital data, and the connection between the connecting pins P3 and P4 and the connecting portions H3 and H4 sends the digital data to the CPU in the control section 26. Consequently, the control section 26 detects that the continuous power is ensured from the cradle 4.

Here, a description is given of an actual method for supplying power.

It is assumed that an AC-adaptor voltage is higher than an inner-secondary-battery voltage. For example, it is assumed that the AC adaptor voltage is 5V, the inner-secondary-battery voltage is 3.0 to 4.2V in the case of one lithium ion cell.

Upon using the AC adaptor 5a, current flows through a route I1. A reverse-flow preventing diode 31 prevents the power supply to the AC adaptor 5a side from an inner secondary battery 30 having a voltage lower than the AC adaptor voltage. A reverse-flow preventing diode 32 prevents the reverse flow of the current to the battery 30. The control section 26 reads a voltage value (approximately 5V) in this case by the A/D converter 28a, thereby detecting the AC power supply (AC 100V).

Upon using the inner secondary battery 30, the current flows through a route I2. The control section 26 reads a voltage value (approximately 4.2V or less) by the A/D converter 28a, thereby detecting the power supply from the inner secondary battery 30. Further, the control section 26 calculates the remaining amount of battery of the inner secondary battery 30 based on the voltage value.

FIG. 3 shows a status in which the mobile phone main body 2 is placed on the cradle 4.

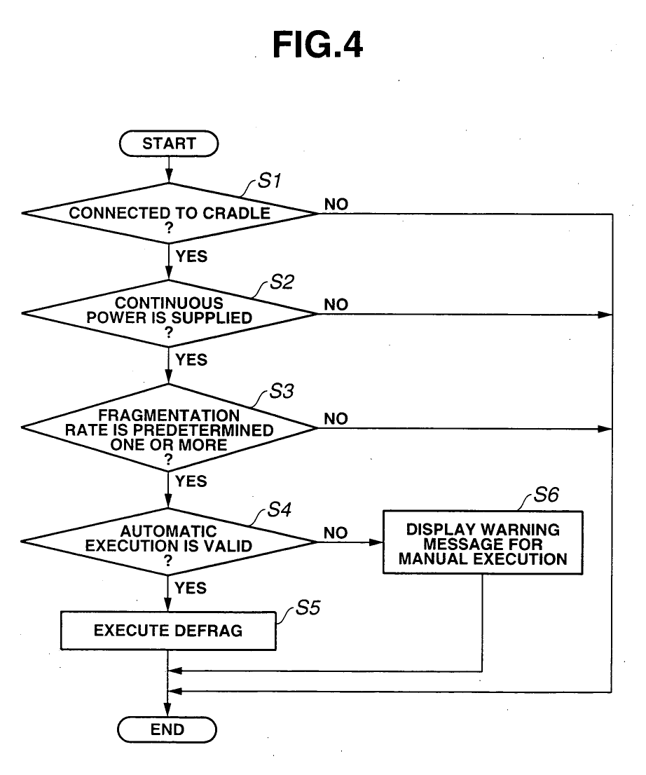

Next, a description is given of the operation of defragmentation according to the first embodiment of the present invention with reference to FIG. 4.

FIG. 4 is a flowchart showing the operation for the defragmentation according to the first embodiment. According to the first embodiment, as mentioned above, it is set by operating the input section 25 and by executing the setting program whether or not the automatic execution of defragmentation is valid (in other words, whether the automatic execution of defragmentation or the manual execution of defragmentation is performed).

First, the mobile phone main body 2 is connected (placed) to the cradle 4, thereby detecting the connection by the cradle detecting section 27 (step S1). Further, the power status determining section 28 detects whether or not the continuous power-supply section 5 supplies continuous power to the mobile phone main body 2 (step S2).

When the mobile phone main body 2 is connected to the cradle 4 and the continuous power exists, the control section 26 checks to see if the fragmentation rate of the HDD 24 is a predetermined value or more (step S3). When the fragmentation of the HDD 24 is a predetermined value or more and the user permits (sets) the automatic execution of defragmentation, the defragmentation is automatically executed (steps S4 and S5).

In step S4, it is checked to see if the automatic execution of defragmentation is valid. When the automatic execution of defragmentation is valid in step S4, the processing advances to step S5. Thus, the defragmentation is executed by the continuous power in the stable status of the HDD 24 which is weak in vibrations without the unnecessary power-consumption of the battery. Further, the fragmentation rate is continuously kept to be a predetermined value or less without the user's complicated operation.

In step S4, the user who does not want the automatic execution of defragmentation sets, by using the input section 25, the automatic execution of defragmentation to be invalid. When it is set that the automatic execution of defragmentation is invalid, the display section 22 displays the warning message when the fragmentation rate is a predetermined value or more, and the manual operation of defragmentation is promoted to the user (step S6).

Even in the manual operation of defragmentation, a problem of the HDD damage and the unnecessary power-consumption of battery due to the vibrations is caused if the defragmentation is executed in the mobile status. Therefore, even in the manual operation of defragmentation, preferably, the defragmentation is executed only in the status in which the mobile phone main body 2 is placed onto the cradle 4 and the continuous power is ensured.

According to the first embodiment, the damage of the HDD 24 due to the vibrations is prevented by detecting the status of ensuring the continuous power and by executing the defragmentation while the mobile phone main body 2 is placed on the cradle 4. Further, the unnecessary power-consumption of battery is prevented. Furthermore, the fragmentation rate of the HDD 24 is continuously kept to be a predetermined value or less without the user's complicated operation.

Since the operation for reading/writing the data during the defragmentation is repeated, the consumption power is increased. However, the continuous power results in supplying the stable power to the HDD 24.

[Second Embodiment]

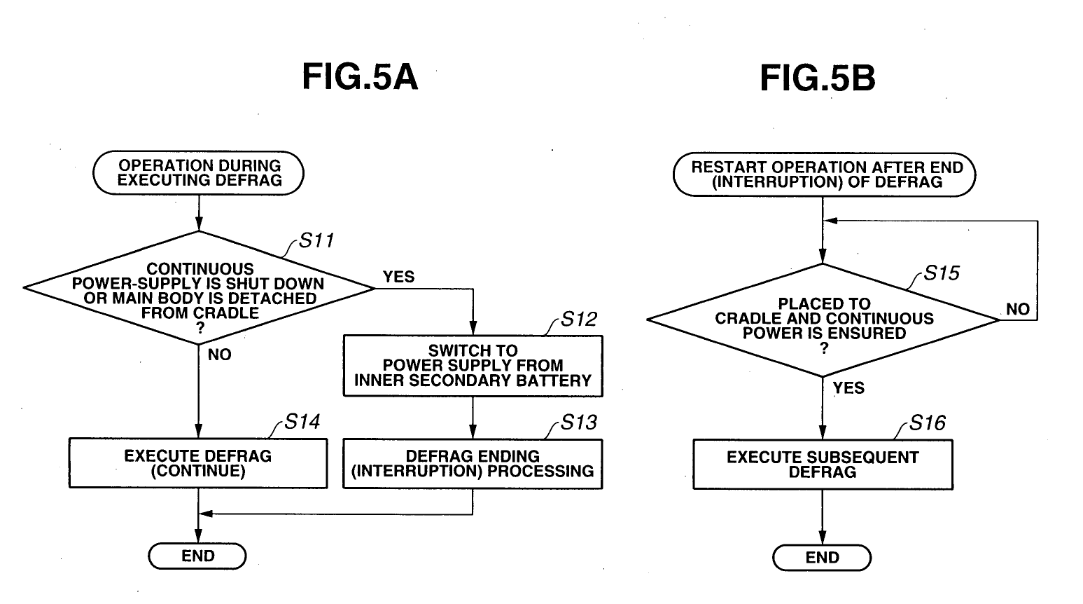

FIGS. 5A and 5B are flowcharts for the operation of defragmentation in a recording system and a recording device according to a second embodiment of the present invention. The structure of the recording system and the recording device is the same as that shown in FIG. 1.

FIG. 5A is a flowchart for the operation when the continuous power is shut down during executing the defragmentation or the mobile phone main body 2 is detached from the cradle 4.

Referring to FIG. 5A, during the defragmentation, it is determined whether the continuous power is supplied or is shut down, or whether or not the mobile phone main body 2 is detached from the cradle 4 (step S11). When it is detected that the continuous power is shut down or that the mobile phone main body 2 is detached from the cradle 4, the CPU in the control section 26 switches the power supply to that from the inner secondary battery 30 by using switching section (not shown) (step S12). The defragmentation ending processing (that is, interrupt processing) is performed and then is ended (step S13). When it is detected that the continuous power is not shut down or that the mobile phone main body 2 is not detached from the cradle 4, the defragmentation in progress continues (step S14).

After the end (interrupt) of the defragmentation in step S13 in FIG. 5A, the flow for re-starting the operation is shown in FIG. 5B.

Referring to FIG. 5B, it is determined whether or not the mobile phone main body 2 is placed onto the cradle 4 and the continuous power is ensured (step S15). The determination in step S15 is performed until the mobile phone main body 2 is placed to the cradle 4 or the supply of continuous power restarts. When the CPU detects in step S15 that the mobile phone main body 2 is placed on the 4 and the continuous power is ensured, the operation is controlled so that the defragmentation subsequent to the previous one is performed (step S16).

According to the second embodiment, even when the supply of continuous power is shut down or the mobile phone main body 2 is detached from the mobile phone main body 2 during executing the defragmentation, by restarting the supply of continuous power and/or placing the mobile phone main body 2 to the cradle 4, the subsequent defragmentation is automatically executed and ends.

[Third Embodiment]

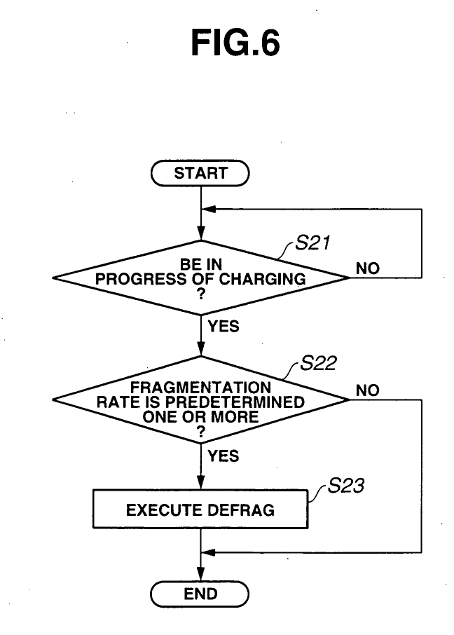

FIG. 6 is a flowchart showing the operation of defragmentation in a recording system and a recording device according to a third embodiment of the present invention. The structure of the recording system and the recording device is the same as that shown in FIG. 1. However, the present invention can be applied to a charging device without using the power supply of the cradle 4.

According to the third embodiment, a description is given of the operation of detecting the charging operation in the mobile device without the cradle and of executing the automatic execution of defragmentation.

Referring to FIG. 6, it is determined whether or not the mobile device is being charged (step S21). When it is determined in step S21 that the mobile device is being charged, it is determined whether or not the fragmentation rate of the HDD 24 as the recording medium is a predetermined value or more (step S22). When it is determined that the fragmentation rate of the HDD 24 is a predetermined value or more, the defragmentation is executed (step S23). When it is determined in step S22 that the fragmentation rate is not a predetermined value or more, the defragmentation is not executed (step S23).

According to the third embodiment, it is detected that the mobile device is being charged and the defragmentation is executed during the charging operation. Since the mobile device is relatively stable during the charging operation, the influence of vibrations is suppressed, as compared with the case of executing the defragmentation in the mobile status. Further, since the defragmentation is executed during the charging operation, the unnecessary power-consumption of battery is prevented.

[Fourth Embodiment]

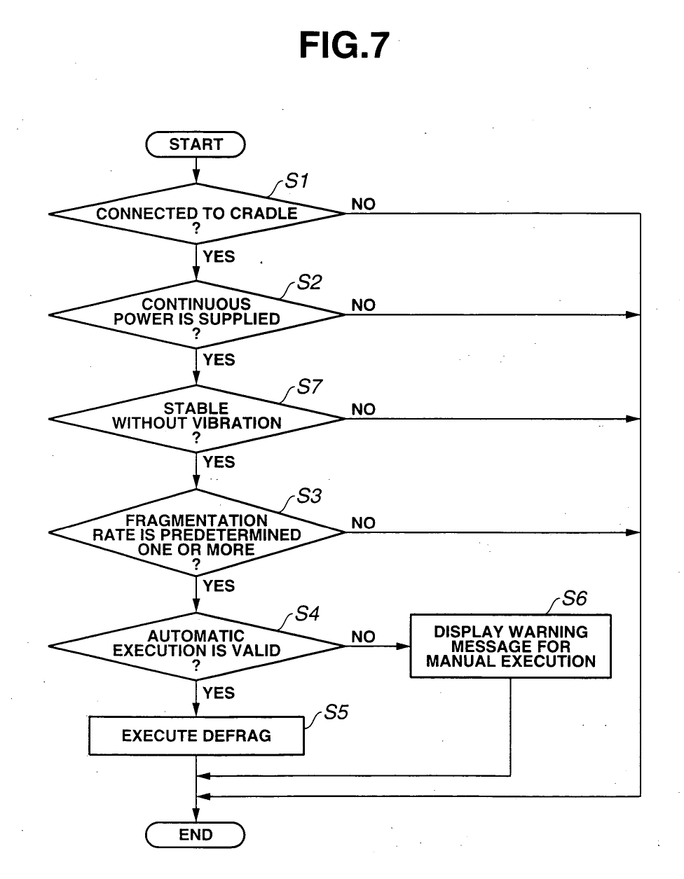

FIG. 7 is a flowchart for the operation of defragmentation in a recording system and a recording device according to a fourth embodiment of the present invention. The structure of the recording system and the recording device is the same as that shown in FIG. 1.

According to the forth embodiment, a description is given of the operation in which a vibration sensor 40 is added to the mobile phone main body 2, an output of the vibration sensor is supplied to the detecting terminal of the CPU of the control section 26, the CPU detects a stable status without vibrations for a predetermined time, and the defragmentation is executed so as to detect the cradle and continuous power and further certainly detect the stable status of the mobile phone main body 2 without vibrations.

The flowchart shown in FIG. 7 is the same as that shown in FIG. 4, other than the addition of step S7 to the flowchart shown in FIG. 4 for describing the operation shown in FIG. 1.

The mobile phone main body 2 is connected (placed) on the cradle 4 and then the connection is detected by the cradle detecting section 27 in the mobile phone main body 2 (step S1). Further, the power status determining section 28 detects whether or not the continuous power-supply section 5 supplies the continuous power to the mobile phone main body 2 (step S2). Further, it is determined, based on the output status of the vibration sensor, whether or not the mobile phone main body 2 is stable without vibrations (step S7).

When it is detected that the mobile phone main body 2 is connected to the cradle 4, the continuous power is supplied, and the vibration sensor does not detect any vibrations for a predetermined time, the control section 26 checks to see if the fragmentation rate of the HDD 24 is a predetermined value or more (step S3). When the fragmentation rate of the HDD 24 is a predetermined value or more and the user permits (sets) the automatic execution of defragmentation, the defragmentation is automatically executed (steps S4 and S5). In step S4, the control section 26 checks to see if the automatic execution of defragmentation is valid. When the automatic execution of defragmentation is valid in step S4, the processing advances to step S5.

Similarly to that shown in FIG. 4, the user who does not want the automatic execution of defragmentation sets, by using the input section 25, the automatic execution of defragmentation to be invalid. When it is set that the automatic execution of defragmentation is invalid, the display section 22 displays the warning message when the fragmentation rate is a predetermined value or more, and then the manual operation of defragmentation is promoted to the user (step S6). In the manual execution of defragmentation, the defragmentation is executed only when the mobile phone main body 2 is placed on the cradle 4, the continuous power is ensured, and the mobile phone main body 2 is stable without vibrations.

According to the fourth embodiment, the defragmentation is executed in the stable status of the HDD 24 that is weak in vibrations without unnecessary power-consumption of battery. The fragmentation rate is continuously kept to be a predetermined value or less without the user's complicated operation.

The present invention is not limited to the mobile device and can be widely applied to a recording device having a recording medium such as an HDD placed under an environment that is easily influenced by the vibrations.

Having described the preferred embodiments of the invention referring to the accompanying drawings. It should be understood that the present invention is not limited to those precise embodiments and various changes and modifications thereof could be made by one skilled in the art without departing from the spirit or scope of the invention as defined in the appended claims.

1. A recording device comprising:
a recording medium for recording an information signal;
a first detecting section which detects that the recording medium is connected to a power supply;
a second detecting section which detects that continuous power is supplied to the recording device from the power supply;
a third detecting section which detects that a fragmentation rate of the information signal recorded to the recording medium is a predetermined value or more; and
a defragmentation automatic executing section which automatically executes defragmentation of the recording medium when the first detecting section detects the connection to the power supply, the second detecting section detects a status for ensuring the continuous power, and the third detecting section detects that the fragmentation rate of the recording medium is a predetermined value or more.

2. A recording device according to claim 1, further comprising:
a vibration sensor which detects that the recording device is stable without vibrations;
wherein the defragmentation automatic executing section automatically executes defragmentation of the recording medium when the first detecting section detects the connection to the power supply, the second detecting section detects a status for ensuring the continuous power, the vibration sensor detects that no vibrations generate for a predetermined time, and the third detecting section detects that the fragmentation rate of the recording medium is a predetermined value or more.

3. A recording device according to claim 1, further comprising:
a setting section which sets whether or not the automatic execution of defragmentation of the recording medium is valid; and
a warning message generating section which generates a warning message for prompting the manual execution of defragmentation when the first detecting section detects the connection to the power supply, the second detecting section detects that the continuous power is ensured, and the third detecting section detects that the fragmentation rate of the recording medium is a predetermined value or more, in a state in which the setting section sets the automatic execution of defragmentation to be invalid;
wherein the defragmentation automatic executing section automatically executes defragmentation of the recording medium when the first detecting section detects the connection to the power supply, the second detecting section detects a status for ensuring the continuous power, and the third detecting section detects that the fragmentation rate of the recording medium is a predetermined value or more, in a state in which the setting section sets the automatic execution of defragmentation to be valid.

4. A recording device according to claim 1, further comprising:
an inner secondary battery;
a fourth detecting section which detects that continuous power is shut down or the recording device is detached from the power supply during executing the defragmentation;
a switching section which switches the power supply to that from the inner secondary battery when the fourth detecting section detects that the continuous power is shut down or the recording device is detached from the power supply;
an ending section which ends the defragmentation when the switching section switches the power supply to that from the inner secondary battery;
a fifth detecting section which detects that the recording device is connected to the power supply and the continuous power is ensured after the ending section ends the defragmentation; and
a control section which controls an operation for executing the subsequent defragmentation when the fifth detecting section detects that the recording device is connected to the power supply and the continuous power is ensured.

5. A recording device according to claim 2, further comprising:
an inner secondary battery:
a fourth detecting section which detects that continuous power is shut down or the recording device is detached from the power supply during executing the defragmentation;
a switching section which switches the power supply to that from the inner secondary battery when the fourth detecting section detects that the continuous power is shut down or the recording device is detached from the power supply;
an ending section which ends the defragmentation when the switching section switches the power supply to that from the inner secondary battery;
a fifth detecting section which detects that the recording device is connected to the power supply and the continuous power is ensured after the ending section ends the defragmentation; and
a control section which controls an operation for executing the subsequent defragmentation when the fifth detecting section detects that the recording device is connected to the power supply and the continuous power is ensured.

6. A recording device according to claim 3, further comprising:
an inner secondary battery:
a fourth detecting section which detects that continuous power is shut down or the recording device is detached from the power supply during executing the defragmentation;
a switching section which switches the power supply to that from the inner secondary battery when the fourth detecting section detects that the continuous power is shut down or the recording device is detached from a power supply;
an ending section which ends the defragmentation when the switching section switches the power supply to that from the inner secondary battery;
a fifth detecting section which detects that the recording device is connected to the power supply and the continuous power is ensured after the ending section ends the defragmentation; and
a control section which controls an operation for executing the subsequent defragmentation when the fifth detecting section detects that the recording device is connected to the power supply and the continuous power is ensured.

7. A recording method of a recording device for defragmentation of an information signal recorded to a recording medium provided for the recording device, the recording method comprising:
a first detecting step of detecting that a recording medium is connected to a power supply;
a second detecting step of detecting that continuous power is supplied to the recording device from the power supply;
a third detecting step of detecting that a fragmentation rate of the information signal recorded to the recording medium is a predetermined value or more; and
a defragmentation automatic executing step of automatically executing defragmentation of the recording medium when the first detecting step detects the connection to the power supply, the second detecting step detects a status for ensuring the continuous power, and the third detecting step detects that the fragmentation rate of the recording medium is a predetermined value or more.

8. A recording system comprising:
a cradle which can supply power to a mobile device including a recording medium by placing the mobile device thereon;
a first detecting section which is arranged to the mobile device and detects that the mobile device is placed on the cradle;
a second detecting section which is arranged to the mobile device and detects that continuous power is supplied to the mobile device from the cradle;
a third detecting section which is arranged to the mobile device and detects that a fragmentation rate of the information signal recorded to the recording medium is a predetermined value or more; and
a defragmentation automatic executing section which automatically executes defragmentation of the recording medium when the first detecting section detects the mobile device is placed on the cradle, the second detecting section detects a status for ensuring the continuous power, and the third detecting section detects that the fragmentation rate of the recording medium is a predetermined value or more.

9. A recording system according to claim 8, further comprising:
a vibration sensor which is arranged to the mobile device and detects that the mobile device is stable without vibrations;
wherein the defragmentation automatic executing section automatically executes defragmentation of the recording medium when the first detecting section detects that the mobile device is placed on the cradle, the second detecting section detects a status for ensuring the continuous power, the vibration sensor detects that no vibrations generate for a predetermined time, and the third detecting section detects that the fragmentation rate of the recording medium is a predetermined value or more.

10. A recording system according to claim 8, further comprising:
a setting section which sets whether or not automatic execution of the defragmentation of the recording medium is valid; and
a warning message generating section which generates a warning message for prompting the manual execution of defragmentation when the first detecting section detects that the mobile device is placed on the cradle, the second detecting section detects that the continuous power is ensured, and the third detecting section detects that the fragmentation rate of the recording medium is a predetermined value or more, in a state in which the setting section sets that the automatic execution of defragmentation is invalid;
wherein the defragmentation automatic executing section automatically executes defragmentation of the recording medium when the first detecting section detects that the mobile device is placed on the cradle, the second detecting section detects a status for ensuring the continuous power, and the third detecting section detects that the fragmentation rate of the recording medium is a predetermined value or more, in a state in which the setting section sets that the automatic execution of defragmentation is valid.
